(19) United States
(12) Patent Application Publication
(10) Pub. No.: US 2022/0194160 A1
(43) Pub. Date: Jun. 23, 2022

(54) ANTI-ROLL BAR CLAMP, ANTI-ROLL BAR/ANTI-ROLL BAR CLAMP ASSEMBLY, AND METHOD FOR PRODUCING AN ANTI-ROLL BAR CLAMP

(71) Applicants: ThyssenKrupp Federn und Stabilisatoren GmbH, Hagen (DE); Thyssenkrupp AG, Essen (DE)

(72) Inventors: Patrick BESTING, Attendorn (DE); Sebastian BERNARD, Köln (DE)

(73) Assignees: ThyssenKrupp Federn und Stabilisatoren GmbH, Hagen (DE); thyssenkrupp AG, Essen (DE)

(21) Appl. No.: 17/432,602

(22) PCT Filed: Feb. 7, 2020
(86) PCT No.: PCT/EP2020/053147

§ 371 Date: Aug. 20, 2021

(30) Foreign Application Priority Data
Feb. 20, 2019 (DE) 10 2019 202 306.1

(51) Int. Cl. B60G 21/055

(52) U.S. Cl. CPC B60G 21/0551; B60G 2206/8206; B60G 2204/1222; B60G 2202/135

(57) ABSTRACT

A stabilizer clamp for a vehicle stabilizer may include an inner region for receiving a vehicle stabilizer and at least two at least partially opposite end regions for closing the stabilizer clamp. A first of the at least two at least partially opposite end regions may have a connecting element, and a second of the at least two at least partially opposite end regions may have a connecting element receptacle for producing at least a form-fitting connection between the connecting element and the connecting element receptacle. The connecting element may be at least one rivet, and the at least one connecting element receptacle is at least one rivet hole, and the form-fitting connection that is produced is at least a riveted connection.

The present invention relates to a stabilizer clamp, to a stabilizer/stabilizer clamp assembly and also to a method for producing a stabilizer clamp.

### PRIOR ART

(Vehicle) stabilizers for (motor) vehicles are known from the prior art in a large number of embodiments and are also referred to, for example, as stabilizers, stabilizing torsion bars or torsion spring bars. These stabilizing torsion bars serve for stabilizing against tilting and distortion of the vehicle body, in particular during cornering and tuning of the driving behavior of a (motor) vehicle. Such stabilizers are routinely arranged in the region of the front and the rear axle and usually extend over the entire width of the vehicle. The fastening of such stabilizers to the running-gear unit on the one hand and to the vehicle body on the other hand is associated with the problem that the vibrations, oscillations and noises, such as, for example, wheel noises and roadway noises, which arise and appear at the running-gear unit and/or are taken up by the running-gear unit are transmitted via the fastening to the vehicle body and thus also into the passenger cell. In order to damp, in particular to reduce, this transmission, the stabilizers are typically fastened with damping via stabilizer bearings. These stabilizer bearings are also known in the prior art as sleeve bearings which have a rigid outer sleeve, also referred to as stabilizer clamp, and an elastic insert element arranged coaxially in the inner region of this stabilizer clamp. Equally known is the arrangement of an elastic insert element on a stabilizer, with the stabilizer being fastened via the elastic insert element, which is arranged on the latter, with the stabilizer clamp to a vehicle underfloor. There is generally a rigid stabilizer clamp which is fastened to a vehicle underfloor, with an elastic insert element, which is arranged coaxially around a stabilizer, being inside this stabilizer clamp. These aforementioned bearings can be distinguished in terms of their mode of action into sliding bearings, clamping bearings, adhesive bearings and bonding bearings.

For fastening the stabilizer bearings to the running-gear unit and the vehicle body, the prior art discloses a large number of arrangements and fastening possibilities which do not change the basic function of the stabilizer bearing. For example, a stabilizer bearing can be fastened with a stabilizer clamp to the running-gear unit and/or the vehicle body. What is problematic is that the assembly process for mounting stabilizer clamps on the running-gear unit and/or the vehicle body is particularly laborious in a plurality of method steps, difficult, error-prone and cost-intensive.

The object on which the present invention is based is therefore that of providing an improved stabilizer clamp and/or a stabilizer/stabilizer clamp assembly and an improved method for producing a stabilizer/stabilizer clamp assembly in which the aforementioned disadvantages are avoided. In particular, it is intended by way of this improved stabilizer clamp and/or the stabilizer/stabilizer clamp assembly and the improved method for producing a stabilizer/stabilizer clamp assembly to allow mounting on a vehicle, in particular a running-gear unit, that is simple, non-error-prone, and optimized in terms of fit, process and time. Moreover, the improved method for producing a stabilizer/stabilizer clamp assembly, comprising a stabilizer bonding bearing, is intended to be able to be implemented simply and securely in already existing methods.

### DISCLOSURE OF THE INVENTION

This object is achieved with a stabilizer clamp as claimed in claim 1 and a method for producing a stabilizer/stabilizer clamp assembly as claimed in claim 8 and a method for producing a stabilizer/stabilizer clamp assembly as claimed in claim 9.

As compared with conventional stabilizer clamps, the stabilizer clamp according to the invention has the advantage that, on the one hand, the mounting of the stabilizer clamps on the running-gear unit and/or the vehicle body can be carried out minimalistically, with an accurate fit, simply, in a fault-free manner and so as to be optimized in terms of cost and, on the other hand, there is simultaneously provided a desired prestress in a simple, secure and fault-free manner when arranging a stabilizer in the stabilizer clamp. In particular, overhangs known in the prior art that arise, for example, as a result of protruding screw connections are not present in the connection according to the invention in particular by virtue of a rivet being countersunk after the joining process, and a planar connection, in particular an elevation-free screw support surface, can be realized. Furthermore, the mounting operation, in particular the closing of the stabilizer clamp, requires no additional components, in particular connecting elements, which would have to be additionally arranged on the stabilizer clamp, only with effort, and could, for example, become lost.

As compared with conventional stabilizer/stabilizer clamp assemblies, the stabilizer/stabilizer clamp assembly according to the invention has the advantage that the operation of mounting the stabilizer/stabilizer clamp assembly on the running-gear unit and/or the vehicle body can be carried out simply, in a fault-free manner and optimized in terms of cost. Furthermore, the mounting operation, in particular the closing of the stabilizer clamp, requires no additional components, in particular connecting elements, which would have to be additionally arranged on the stabilizer clamp, only with effort, and could, for example, become lost.

As compared with conventional methods, the method according to the invention for producing a stabilizer/stabilizer clamp assembly has the advantage that the overall process can be optimized, with in particular a higher assembly speed, for example also by saving on complicated intermediate steps, in particular the arrangement of a counter-pressure device for riveting, through a reduced number of elements to be mounted, in particular separate connecting elements, and can also be carried out in an automated manner. A further advantage of the method according to the invention is that it can be simply and reliably integrated into already existing methods.

One subject of the invention is therefore a stabilizer clamp for a vehicle stabilizer, comprising an inner region for receiving a vehicle stabilizer and at least two at least partially opposite end regions for closing the stabilizer clamp, wherein the one of the at least two at least partially opposite end regions has at least one connecting element, and the other of the at least two at least partially opposite end regions has at least one connecting element receptacle for producing at least a form-fitting connection between the at least one connecting element and the at least one connecting element receptacle, wherein the at least one connecting element is at least one rivet, and the at least one connecting element receptacle is at least one rivet hole, and the at least form-fitting connection which can be produced is at least one riveted connection.

A further subject of the invention is a stabilizer/stabilizer clamp assembly comprising a stabilizer, an insert element and a stabilizer clamp, wherein the insert element and the stabilizer are arranged coaxially in the inner region of the stabilizer clamp, wherein the insert element at least partially surrounds the stabilizer.

A further subject of the invention is a method for producing a stabilizer/stabilizer clamp assembly, comprising the following steps:
a) providing a stabilizer clamp as claimed in one of the preceding claims 1 to 7, the stabilizer clamp at least comprising an inner region for receiving a vehicle stabilizer and at least two at least partially opposite end regions for closing the stabilizer clamp, wherein the one of the at least two at least partially opposite end regions has at least one connecting element, and the other of the at least two at least partially opposite end regions has at least one connecting element receptacle for producing at least a form-fitting connection between the at least one connecting element and the at least one connecting element receptacle, wherein the at least one connecting element is at least one rivet, and the at least one connecting element receptacle is at least one rivet hole;
b) providing a stabilizer for a vehicle, in particular a (motor) vehicle;
c) providing at least one elastic insert element;
d)
   i. inserting the at least one elastic insert element provided in step c) into the inner region of the stabilizer clamp provided in step a) so as to produce a stabilizer clamp with insert, or
   ii. arranging the at least one elastic insert element provided in step c) on the stabilizer provided in step b) so as to produce a stabilizer with arranged insert;
e)
   i. arranging the stabilizer clamp with insert produced in step d)i. around the stabilizer provided in step b), or
   ii. arranging the stabilizer clamp provided in step a) around the stabilizer with arranged insert that is produced in step d)ii.;
f) closing the stabilizer clamp arranged in step e)i. or e)ii. around the stabilizer and the at least one elastic insert element, wherein the at least two at least partially opposite end regions of the stabilizer clamp are arranged in such a way that the at least one rivet is inserted into the at least one rivet hole;
g) riveting the rivet inserted in step f) into the at least one rivet hole so as to produce an at least form-fitting connection.

A further subject of the invention is the use of a stabilizer, in particular a vehicle stabilizer, for arranging a stabilizer clamp.

The invention can be realized not only in the stabilizer clamp but also in a stabilizer/stabilizer clamp assembly and in a method for producing a stabilizer clamp and in the use of a stabilizer.

### DETAILED DESCRIPTION OF THE INVENTION

By way of example, the geometric base area of a rivet and associated rivet hole is selected from a group consisting of a polygon, in particular a trigon, a tetragon, a pentagon, a hexagon, a heptagon, an octagon, a nonagon, a decagon, a hendecagon, a dodecagon, an ellipse, in particular a circle or a combination thereof. For example, the rivet can take the form of a hollow body, in particular of a hollow cylinder, or be solid in form.

According to a preferred embodiment of the invention, the stabilizer clamp has at least two rivets and at least two rivet holes, wherein the at least two rivets and the at least two rivet holes each have a like-sided or alternate-sided arrangement.

Within the scope of the present invention, what is to be understood by a like-sided arrangement is an arrangement in which the at least two rivets or the at least two rivet holes are arranged on the same of the mutually opposite end regions.

What is to be understood by alternate-sided arrangement in the scope of the present invention is an arrangement in which the at least two rivets or the at least two rivet holes are not arranged on the same of the mutually opposite end regions.

According to a preferred embodiment of the invention, the at least one rivet is formed in one piece with the stabilizer clamp.

There are thus required no further connecting elements, in particular joining components for closing the stabilizer clamp. The connecting elements, in particular the joining region, are generated from the stabilizer clamp itself. This makes it possible in particular to save on additional connecting elements, in particular joining components (such as, for example, loose rivets which would have to be supplied and arranged in a further assembly step). In particular with the formation of the riveting region on the stabilizer clamp, the riveting region and the stabilizer clamp have the same material composition and same material properties, such as, for example, the same strength properties, this particularly also having advantageous effects on corrosion properties. For example, closing the stabilizer clamp requires no (additional) counter-holder and also no rivet base for the riveting process, since the rivet base is formed by the stabilizer clamp itself.

Within the scope of the present invention, what is to be understood by one-piece is that no piece can be divided into a plurality of pieces in a destruction-free manner.

In a preferred embodiment of the invention, the stabilizer clamp is formed in one piece, in particular stamped from one piece, or is formed in multiple pieces, in particular in two pieces or three pieces. For example, the stamped stabilizer clamp is substantially produced as a stamped and bent part.

Within the scope of the present invention, what is to be understood by one-piece is a piece which can be divided into a plurality of pieces only through destruction of material.

According to a preferred embodiment of the invention, at least one of the at least two at least partially opposite end regions has at least one attachment element for attaching to a vehicle, in particular to a vehicle chassis, a vehicle running-gear unit, a vehicle frame, a vehicle underfloor or combination thereof. An attachment element for example takes the form of at least a form-fitting connecting receptacle, such as, for example, selected from a connecting opening, in particular a bore, a threaded bore, a cutout, an oblong hole or a combination thereof.

In a preferred embodiment of the invention, the inner region has a geometric formation, in particular at least one elevation, at least one depression and/or at least one at least partially encircling contour for form-fittingly securing an elastic insert element arranged in the inner region. A geometric formation is for example selected from a nub, a latching lug, a groove, a bead, a collar or a combination thereof.

Within the scope of the present invention, what is to be understood by an insert element is an element which elastically connects a stabilizer clamp into which it is inserted and a stabilizer which is at least partially enclosed by the insert element of the stabilizer clamp arranged around the stabilizer. For example, an insert element takes the form of an elastic bearing, in particular a rubber bearing for mounting a stabilizer. An insert element can, for example, also take the form of a push-in element.

According to a preferred embodiment of the invention, the stabilizer clamp has a coating, in particular taking the form of a sacrificial coating, for example a zinc-nickel coating.

What is to be understood by a sacrificial coating within the scope of the present invention is a coating for corrosion protection. In particular, the sacrificial coating protects the stabilizer clamp to which the sacrificial coating is applied, and the sacrificial coating itself is sacrificed in a corrosive environment.

According to a preferred embodiment of the invention, the at least form-fitting connection produced in step g) additionally takes the form of a force-fitting connection.

In a preferred embodiment of the invention, the at least one rivet of the stabilizer clamp provided in step a) is formed in one piece with the stabilizer clamp.

Within the scope of the present invention, what is to be understood by one-piece is that no piece can be divided into a plurality of pieces in a destruction-free manner.

The invention comprises the following further embodiments:
1. Stabilizer clamp (1) for a vehicle stabilizer (2), comprising an inner region (3) for receiving a vehicle stabilizer (2) and at least two at least partially opposite end regions (4, 4′, 4″) for closing the stabilizer clamp (1), wherein the one of the at least two at least partially opposite end regions (4, 4′, 4″) has at least one connecting element (5, 5′, 5″, 5′″), and the other of the at least two at least partially opposite end regions (4, 4′, 4″) has at least one connecting element receptacle (6, 6′, 6″, 6′″) for producing at least a form-fitting connection between the at least one connecting element (5, 5′, 5″, 5′″) and the at least one connecting element receptacle (6, 6′, 6″, 6″), wherein the at least one connecting element (5, 5′, 5″, 5′″) is at least one rivet, and the at least one connecting element receptacle (6, 6′, 6″, 6″) is at least one rivet hole, and the at least form-fitting connection which can be produced is at least one riveted connection.
2. Stabilizer clamp (1) according to embodiment 1, wherein the stabilizer clamp (1) has at least two rivets and at least two rivet holes, wherein the at least two rivets and the at least two rivet holes each have a like-sided or alternate-sided arrangement.
3. Stabilizer clamp (1) according to either of embodiments 1 and 2, wherein the stabilizer clamp (1) is formed in one piece or in multiple pieces.
4. Stabilizer clamp (1) according to one of embodiments 1 to 3, wherein the riveted connection additionally takes the form of a force-fitting connection.
5. Stabilizer clamp (1) according to one of embodiments 1 to 4, wherein at least one of the at least two at least partially opposite end regions (4, 4′, 4″) has at least one attachment element (7, 7′) for attaching to a vehicle.
6. Stabilizer clamp (1) according to one of embodiments 1 to 5, wherein the inner region (3) has a geometric formation, in particular at least one elevation and/or at least one depression for form-fittingly securing an elastic insert element (8) arranged in the inner region (3).
7. Stabilizer clamp (1) according to one of embodiments 1 to 6, wherein the stabilizer clamp (1) has a coating, in particular taking the form of a sacrificial coating.
8. Stabilizer/stabilizer clamp assembly comprising a stabilizer (2), an insert element (8) and a stabilizer clamp (1) according to one of embodiments 1 to 7, wherein the insert element (8) and the stabilizer (2) are arranged coaxially in the inner region (3) of the stabilizer clamp (1), wherein the insert element (8) at least partially surrounds the stabilizer (2).
9. Method for producing a stabilizer/stabilizer clamp assembly (9), comprising the following steps:
   a) providing a stabilizer clamp (1) according to one of the previous embodiments 1 to 7, the stabilizer clamp (1) at least comprising an inner region (3) for receiving a vehicle stabilizer (2) and at least two at least partially opposite end regions (4, 4′, 4″) for closing the stabilizer clamp (1), wherein the one of the at least two at least partially opposite end regions (4, 4′, 4″) has at least one connecting element (5, 5′, 5″, 5′″), and the other of the at least two at least partially opposite end regions (4, 4′, 4″) has at least one connecting element receptacle (6, 6′, 6″, 6″) for producing at least a form-fitting connection between the at least one connecting element (5, 5′, 5″, 5′″) and the at least one connecting element receptacle (6, 6′, 6″, 6″), wherein the at least one connecting element (5, 5′, 5″, 5′″) is at least one rivet, and the at least one connecting element receptacle (6, 6′, 6″, 6′″) is at least one rivet hole;
   b) providing a stabilizer (2) for a vehicle, in particular a motor vehicle;
   c) providing at least one elastic insert element (8);
   d)
      i. inserting the at least one elastic insert element (8) provided in step c) into the inner region (3) of the stabilizer clamp (1) provided in step a) so as to produce a stabilizer clamp (1) with insert, or
      ii. arranging the at least one elastic insert element (8) provided in step c) on the stabilizer (2) provided in step b) so as to produce a stabilizer (2) with arranged insert;
   e)
      i. arranging the stabilizer clamp (1) with insert that is produced in step d)i. around the stabilizer (2) provided in step b), or
      ii. arranging the stabilizer clamp provided in step a) around the stabilizer (2) with arranged insert that is produced in step d)ii.;
   f) closing the stabilizer clamp (1) arranged in step e)i. or e)ii. around the stabilizer (2) and the at least one elastic insert element (8), wherein the at least two at least partially opposite end regions (4, 4′, 4″) of the stabilizer clamp (1) are arranged in such a way that the at least one rivet is inserted into the at least one rivet hole;
   g) riveting the rivet inserted in step f) into the at least one rivet hole so as to produce an at least form-fitting connection.
10. Method for producing a stabilizer/stabilizer clamp assembly (9) according to embodiment 9, wherein the at least form-fitting connection produced in step g) additionally takes the form of a force-fitting connection.
11. Use of a stabilizer (2), in particular vehicle stabilizer (2), for arranging a stabilizer clamp (1) according to one of embodiments 1 to 7.

### BRIEF DESCRIPTION OF THE DRAWINGS

The stabilizer clamp and also the stabilizer/stabilizer clamp assembly according to the invention are explained by way of the drawing.

FIG. 1 schematically shows a three-dimensional view of a stabilizer clamp 1 according to one embodiment of the invention in an open state,

FIG. 2 schematically shows a three-dimensional view of a stabilizer clamp 1 according to FIG. 1 in a closed state,

FIG. 3 schematically shows a three-dimensional view of a stabilizer clamp 1 according to a further embodiment of the invention,

FIG. 4 schematically shows a three-dimensional view of a stabilizer clamp 1 according to a further embodiment of the invention,

FIG. 5 schematically shows a three-dimensional view of a stabilizer clamp 1 according to a further embodiment of the invention,

FIG. 6 schematically shows a three-dimensional view of a stabilizer clamp 1 according to a further embodiment of the invention,

FIG. 7 schematically shows a three-dimensional view of a stabilizer/stabilizer clamp 1n assembly according to one embodiment of the invention.

In FIG. 1 there is illustrated one embodiment of the stabilizer clamp 1 according to the invention in an open state for a (vehicle) stabilizer 2. The stabilizer clamp 1 is formed in one part and comprises an inner region 3 and 2 at least partially opposite end regions 4, 4′. One end region 4, 4′ has 2 connecting elements 5, 5′, illustrated as rivets, which, upon closing the stabilizer clamp 1, lead into the connecting element receptacles 6, 6′, illustrated as rivet holes, of the opposite, other end region 4, 4′. For connection to a vehicle, in particular a running-gear unit, the end regions 4, 4′ each comprise attachment elements 7, 7′.

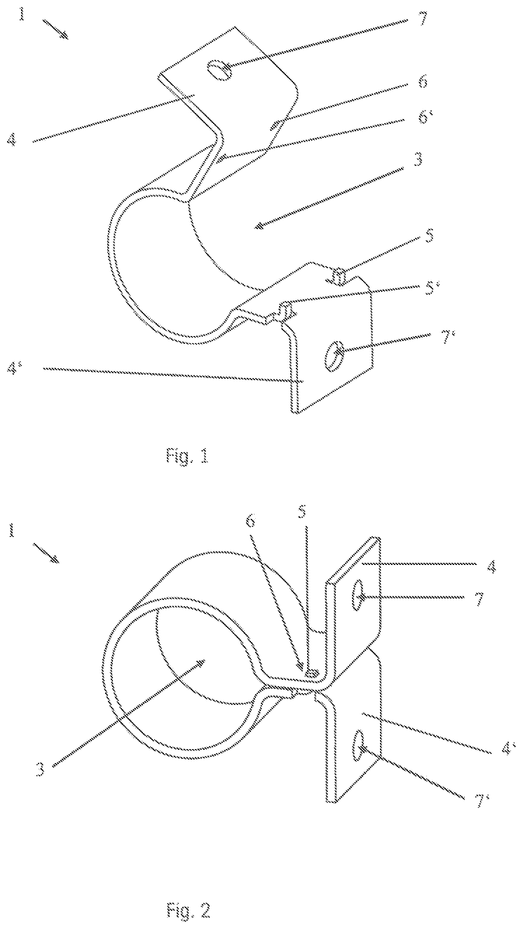

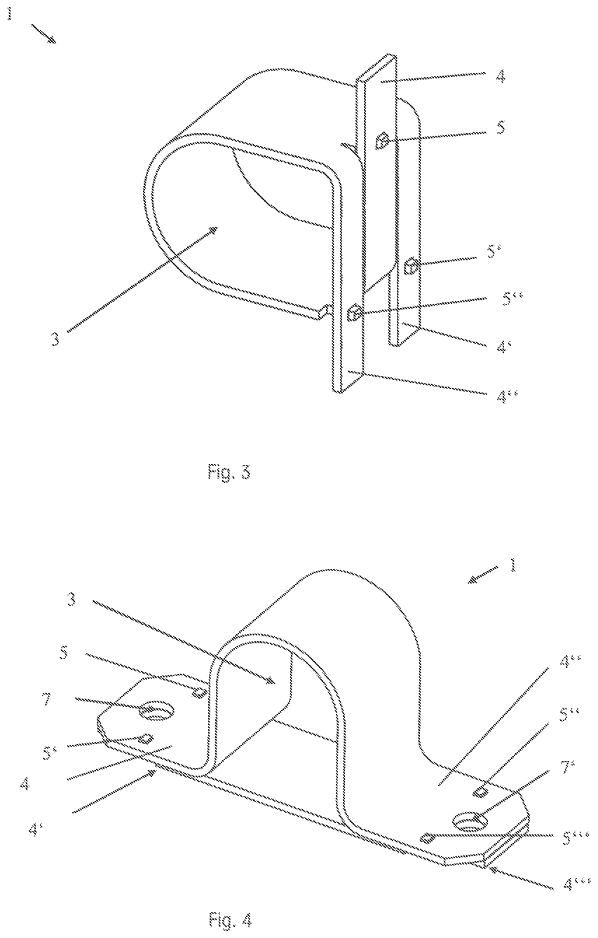

In FIG. 2 there is illustrated the stabilizer clamp 1 according to the invention as shown in FIG. 1 in the closed state. In the closed state, the connecting elements 5 have in particular been guided through the connecting element receptacle 6.

In FIG. 3 there is illustrated a further embodiment of the stabilizer clamp 1 according to the invention for a (vehicle) stabilizer 2 in a closed state. The stabilizer clamp 1 is formed in one part, and comprises an inner region 3 and a plurality of end regions 4, 4′ and 4″. The connecting elements 5, 5′ and 5″ have an alternate-sided arrangement.

In FIG. 4 there is illustrated a further embodiment of the stabilizer clamp 1 according to the invention for a (vehicle) stabilizer 2 in a closed state. The stabilizer clamp 1 is formed in two parts, and comprises an inner region 3 and the end regions 4, 4′, 4″ and 4′″. The connecting elements 5, 5′, 5″ and 5′″ have been guided through the oppositely arranged connecting element receptacles. For connection to a vehicle, in particular a running-gear unit, the end regions 4, 4′, 4″ and 4′″ comprise attachment elements 7, 7′.

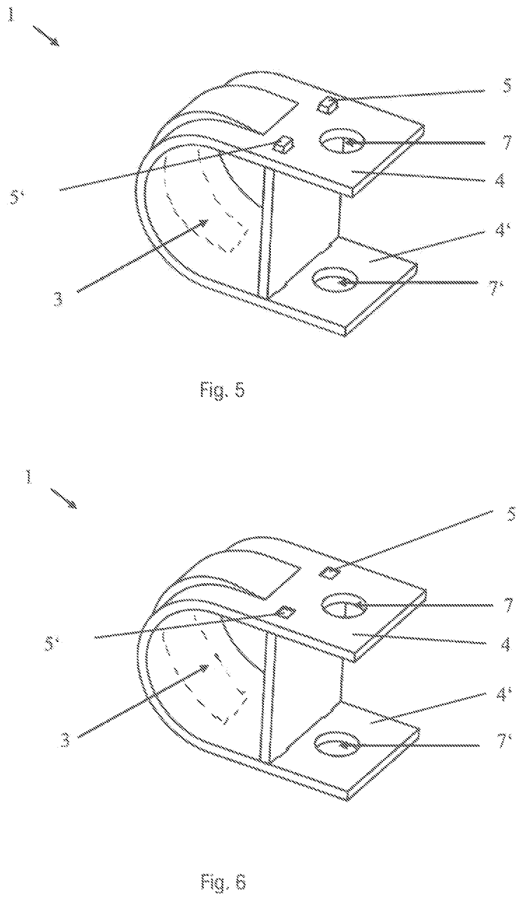

In FIG. 5 there is illustrated a further embodiment of the stabilizer clamp 1 according to the invention for a (vehicle) stabilizer 2 in a closed state. The stabilizer clamp 1 is formed in two parts, and comprises an inner region 3 and the end regions 4, 4′. The connecting elements 5, 5′ have been guided through the oppositely arranged connecting element receptacles (6, 6′). For connection to a vehicle, in particular a running-gear unit, the end regions 4, 4′ comprise attachment elements 7, 7′. The stabilizer clamp 1 has, for the purpose of receiving an insert element (8), a geometric formation in the inner region 3.

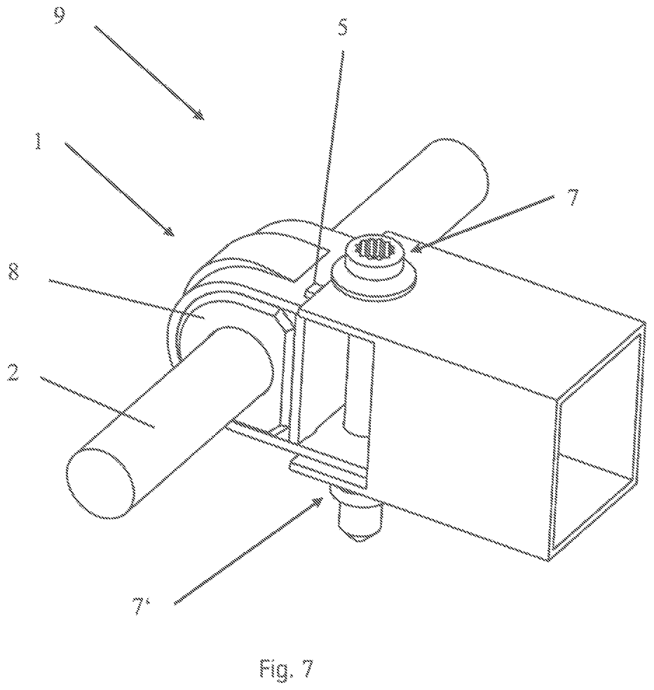

In FIG. 6 there is illustrated an embodiment according to the invention of the stabilizer clamp 1 as shown in FIG. 5; however, the connection between the connecting elements 5, 5′ received in the connecting element receptacles (6, 6′) is riveted.

In FIG. 7 there is illustrated a stabilizer/clamp assembly 9 comprising a stabilizer clamp 1 and a (vehicle) stabilizer 2 arranged therein. Between the stabilizer 2 and the stabilizer clamp 1 there is arranged an insert element 8. In particular, the stabilizer 2 is mounted in the stabilizer clamp 1 via the insert element 8. It is by way of an attachment element 7, 7′ that the stabilizer/stabilizer clamp assembly 9, in particular the stabilizer clamp 1, is attached to a vehicle element, in particular a fastening on a running-gear unit.

### INDUSTRIAL APPLICABILITY

The stabilizer clamp and also the stabilizer/stabilizer clamp assembly and also the method for producing a stabilizer/stabilizer clamp assembly of the above-described type are used in the production of vehicles, in particular of running-gear units of motor and/or rail vehicles.

### LIST OF REFERENCE SIGNS

1=Stabilizer clamp
2=(Vehicle) stabilizer
3=Inner region
4, 4′, 4″=End regions
5, 5′, 5″, 5′=Connecting element
6, 6′, 6″, 6″=Connecting element receptacle
7, 7′=Attachment element
8=Insert element
9=Stabilizer/stabilizer clamp assembly

1.-11. (canceled)

12. A stabilizer clamp for a vehicle stabilizer, comprising:
an inner region for receiving the vehicle stabilizer; and
at least two at least partially opposite end regions for closing the stabilizer clamp, wherein a first of the at least two at least partially opposite end regions includes a connecting element, wherein a second of the at least two at least partially opposite end regions includes a connecting element receptacle for producing a form-fitting connection between the connecting element and the connecting element receptacle, wherein the connecting element includes a rivet, wherein the connecting element receptacle includes a rivet hole, wherein the form-fitting connection to be produced is a riveted connection.

13. The stabilizer clamp of claim 12 comprising at least two rivets and at least two rivet holes, wherein the at least two rivets and the at least two rivet holes each have a like-sided arrangement or an alternate-sided arrangement.

14. The stabilizer clamp of claim 12 wherein the rivet is integral with the stabilizer clamp.

15. The stabilizer clamp of claim 12 wherein the riveted connection is also a force-fitting connection.

16. The stabilizer clamp of claim 12 wherein at least one of the at least two at least partially opposite end regions includes an attachment element configured to attach to a vehicle.

17. The stabilizer clamp of claim 12 wherein the inner region has a geometrical formation comprising an elevation for form-fittingly securing an elastic insert element disposed in the inner region.

18. The stabilizer clamp of claim 12 wherein the inner region has a geometrical formation comprising a depression for form-fittingly securing an elastic insert element disposed in the inner region.

19. The stabilizer clamp of claim 12 comprising a coating.

20. The stabilizer clamp of claim 12 comprising a sacrificial coating.

21. A stabilizer-stabilizer clamp assembly comprising:
a stabilizer;
an insert element; and
a stabilizer clamp comprising:
an inner region for receiving the stabilizer, and
at least two at least partially opposite end regions for closing the stabilizer clamp, wherein a first of the at least two at least partially opposite end regions includes a connecting element, wherein a second of the at least two at least partially opposite end regions includes a connecting element receptacle for producing a form-fitting connection between the connecting element and the connecting element receptacle, wherein the connecting element includes a rivet, wherein the connecting element receptacle includes a rivet hole, wherein the form-fitting connection to be produced is a riveted connection,
wherein the insert element and the stabilizer are arranged coaxially in the inner region of the stabilizer clamp,
wherein the insert element at least partially surrounds the stabilizer.

22. A method for producing a stabilizer-stabilizer clamp assembly, the method comprising:
providing a stabilizer clamp that comprises:
an inner region for receiving a vehicle stabilizer, and
at least two at least partially opposite end regions for closing the stabilizer clamp, wherein a first of the at least two at least partially opposite end regions includes a connecting element, wherein a second of the at least two at least partially opposite end regions includes a connecting element receptacle for producing a form-fitting connection between the connecting element and the connecting element receptacle, wherein the connecting element includes a rivet, wherein the connecting element receptacle includes a rivet hole, wherein the form-fitting connection to be produced is a riveted connection;
providing the vehicle stabilizer;
providing an elastic insert element;
performing one of:
inserting the elastic insert element into the inner region of the stabilizer clamp and arranging the stabilizer clamp with the elastic insert element around the vehicle stabilizer, or
arranging the elastic insert element on the vehicle stabilizer and arranging the stabilizer clamp around the vehicle stabilizer with the elastic insert element;
closing the stabilizer clamp around the vehicle stabilizer and the elastic insert element, wherein the at least two at least partially opposite end regions of the stabilizer clamp are disposed such that the rivet is inserted into the rivet hole; and
riveting the rivet inserted into the rivet hole to produce the form-fitting connection.

23. The method of claim 22 wherein the form-fitting connection is also a force-fitting connection.
